(19) United States
(12) Patent Application Publication
(10) Pub. No.: US 2026/0045431 A1
(43) Pub. Date: Feb. 12, 2026

(54) SWITCHING DEVICE

(71) Applicant: Siemens Energy Global GmbH & Co. KG, München (DE)

(72) Inventor: Christian Schacherer, Deining (DE)

(21) Appl. No.: 19/100,393

(22) PCT Filed: Aug. 3, 2022
(86) PCT No.: PCT/EP2022/071773

§ 371 Date: Jan. 31, 2025

(51) Int. Cl. H01H 33/666; H01H 9/10; H01H 33/14

(52) U.S. Cl. CPC H01H 33/6661; H01H 9/10; H01H 33/14

(57) ABSTRACT

A switching device has a commutation flow path, a first isolating gap, and a second isolating gap. The first isolating gap and the second isolating gap form an electrical series circuit which is arranged parallel to the commutation flow path. The second isolating gap has a first contact, a second contact, and a third contact. The first contact is a moving contact. The first contact is mounted movably along a switching axis from a first galvanic contacting position with the second contact to a second galvanic contacting position with the third contact. In the second contacting position, a mechanical contact force acts between the first contact and the third contact in a radial direction.

The invention relates to a switching device with a commutation current path.

Short circuits may occur in electrical circuits, particularly for medium-voltage or high-voltage power supplies, if the insulation fails or for other reasons. Large currents flow through the short circuit, which may damage or destroy equipment in the power supply network. The expansion of de-centralized feed-in systems can increase the short-circuit current to such an extent that the rated values of the existing equipment are exceeded.

One way of preventing an impermissibly high short-circuit current is to use a current-limiting device, such as a very fast fuse as a short-circuit current limiter.

The principle of these devices is to quickly switch off the short-circuit current in the event of a short circuit. This is achieved by separating the functions. For normal operation, there is a rated current path that can be opened in the event of a short circuit. Parallel to the rated current path, there is another current path (the commutation current path, parallel path) with a fuse that can switch off the short-circuit current.

In the event of a short circuit, the rated current path is opened, creating an arc. The arc voltage causes a complete commutation of the current in the parallel path. The fuse then trips, extinguishing the arc. The impedances of the parallel current path and the rated current path must be matched to each other to enable commutation of the short-circuit current. In addition, the current through the fuse must not be too high during rated operation so that the fuse does not blow prematurely.

There is therefore a conflict of objectives between the highest possible impedance of the parallel current path in rated operation so as not to overload the fuse and the lowest possible impedance in the short-circuit case in order 6 to be able to commutate the current in the parallel current path. To support the commutation of the current from the rated current path to the parallel current path, a high arc burning voltage is advantageous, which arises above all when the rated current path is blown open, which is used in the prior art.

At the moment of contact separation after the last metal bridge has melted, an arc is created of which the burning voltage is practically only determined by the material properties of the contacts and is made up of the voltage drop at the cathode and anode. Increasing the arc burning voltage by extending the arc is not effective here, as the commutation process is already completed at very small contact distances. With typical contact materials, the arc burning voltage is only approximately 20 V. This voltage is too low to commutate higher currents in the parallel path in practical applications, which is why conventional isolating gaps, which are advantageous in themselves because they can be used repeatedly on blown rated current paths, do not appear to be suitable for residual current limiters.

A switching device with two electrically series-connected isolating gaps is known from the laid-open publication DE 10 2020 205 784 A1. The laid-open publication discloses a switching device with a commutation current path, a first isolating gap and a second isolating gap, wherein the first isolating gap and the second isolating gap form an electrical series connection which is arranged parallel to the commutation current path, wherein the second isolating gap has a first contact, a second contact and a third contact, wherein the first contact is designed as a moving contact and wherein the first contact is mounted movably from a first galvanic contacting position with the second contact to a second galvanic contacting position with the third contact, the second contact and the third contact are at an electrical potential, and the first contact is mounted movably along a switching axis.

This known switching device must be comparatively precise, particularly with regard to the position of the third contact and the movement of the first contact from the first contacting position to the second contacting position, in order to enable reliable closing of the second isolating gap in the second contacting position.

The invention addresses the problem of providing a switching device and a method that can be manufactured at low cost.

According to the invention, this problem is solved by a switching device and by a method according to the independent claims. Advantageous embodiments are given in the de-pendent claims.

Disclosed is a switching device having a commutation current path, a first isolating gap and a second isolating gap, wherein the first isolating gap and the second isolating gap form an electrical series circuit which is arranged parallel to the commutation current path, wherein the second isolating gap has a first contact, a second contact and a third contact, wherein the first contact is designed as a moving contact and wherein the first contact is mounted movably from a galvanic first contacting position with the second contact to a second galvanic contacting position with the third contact, the second contact and the third contact are at an electrical potential (i.e., at the same electrical potential), and the first contact is mounted movably (translationally) along a switching axis, wherein in the second contacting position a mechanical contact force is applied between the first contact and the third contact in a radial direction (with respect to the switching axis).

In other words, the contact force acts perpendicular to the direction of movement of the first contact. The contact force therefore acts perpendicular to the switching direction or the switching axis. As a result, there is advantageously no bouncing between the first contact and the third contact when closing. In addition, no high accuracy requirements regarding the axial position of the third contact need to be met when manufacturing the switching device, as the radial contact force can be realized inde-pendently of the axial position of the third contact.

The switching device can be designed so that—the third contact is a clamping contact and the contact force is a (radially acting) clamping force.

Such a clamping force can certainly allow axial movement between the first contact and the third contact. Preferably, the clamping force can have a braking effect on the first contact. In particular, the clamping force can slow down the first contact in such a way that it comes to a standstill in the second galvanic contacting position.

The switching device can be designed so that —the third contact has resilient contact elements (in particular resilient in the radial direction). These resilient contact elements can advantageously realize a clamping effect; they can therefore also be referred to as resilient clamping elements.

The switching device can be designed so that—the third contact has a recess that at least partially accommodates the first contact in the second contacting position.

In the second contacting position, at least a part of the first contact is therefore arranged in the recess. In other words, the first contact and the third contact are designed in such a way that at least a part of the first contact moves into the recess during the movement from the first contacting position to the second contacting position. In this way, a compact structure of the switching device can be achieved.

The switching device can be designed so that—the recess (in the direction of the switching axis) is substantially hollow-cylindrical in shape. Such a recess is relatively easy to manufacture.

The switching device can also be designed so that—the recess and/or the first contact (in the direction of the switching axis) is conical. This can advantageously achieve a clamping effect between the third contact, which has the recess, and the first contact.

The switching device can be designed so that—the second isolating gap is a gas isolating gap. A gas isolating gap has a relatively high arc voltage when it opens. As a result, a comparatively high commutation voltage can be achieved. As a result, the commutation of the current in the commutation current path takes place quickly.

The switching device can be designed so that—the second contact and the third contact of the second isolating gap are spring-mounted in the direction of the switching axis.

This has the advantage that sufficient contact pressure can be achieved, particularly in the first contacting position, which contributes to stronger galvanic contacting.

The switching device can be designed in such a way that—during a switching operation, an intermediate state ex-ists, in which the contacts of the first isolating gap are arranged galvanically contact-free with respect to each other and the contacts of the second isolating gap are arranged galvanically contact-free with respect to each other.

The switching device can be designed so that—in the intermediate state, a switching arc occurs between the contacts of the first isolating gap and a switching arc occurs between the contacts of the second isolating gap.

Thus, during the switching process, a switching arc occurs between the contacts of the first isolating gap and between the contacts of the second isolating gap, resulting in a comparatively high arc voltage in the current path comprising the two isolating gaps, which is also referred to as the rated current path. The high arc voltage leads to reliable commutation of the flowing electric current from the rated current path to the commutation current path.

The switching device can be designed so that —the switching arc of the second isolating gap occurs between the first contact and the second contact.

The second isolating gap, which has a total of three contacts, is preferably designed in such a way that the switching arc is present between the first and the second contact during the switching process.

The switching device can be designed so that—the commutation current path has a fuse and/or a semiconductor element. Such a semiconductor element can be, for example, an IGBT, a transistor, a diode or a MOSFET. A fuse in particular can melt within a few milliseconds due to the high current that commutates into the commutation current path and thus can interrupt the current flow very quickly.

The switching device can be designed in such a way that—the first isolating gap has a fixed contact and a moving contact, the moving contact is mounted so that it can move in translation along the switching axis, and, when the first isolating gap is closed, a mechanical contact force acts between the moving contact and the fixed contact in an axial direction (with respect to the switching axis). The fixed contact can be spring-mounted. The moving contact is in particular the contact driven by a drive.

The switching device can be designed so that—the first isolating gap is a vacuum isolating gap. The switching device can be designed so that—the first isolating gap is designed as a vacuum interrupter.

In contrast to the gas isolating gap, the vacuum isolating gap or vacuum interrupter has the advantage that sufficient insulation can be built up with a relatively short contact stroke (and therefore in a short time). Also disclosed is a method for switching electric current by means of a switching device according to one of the var-iants described above, in which—in the second contacting position, a mechanical contact force is generated between the first contact and the third contact of the second isolating gap in a radial direction (with respect to the switching axis).

The switching device and the method have the same or simi-lar properties and/or advantages.

The invention is explained in greater detail below with reference to exemplary embodiments. Identical reference signs refer to identical or identically acting elements. To this end,

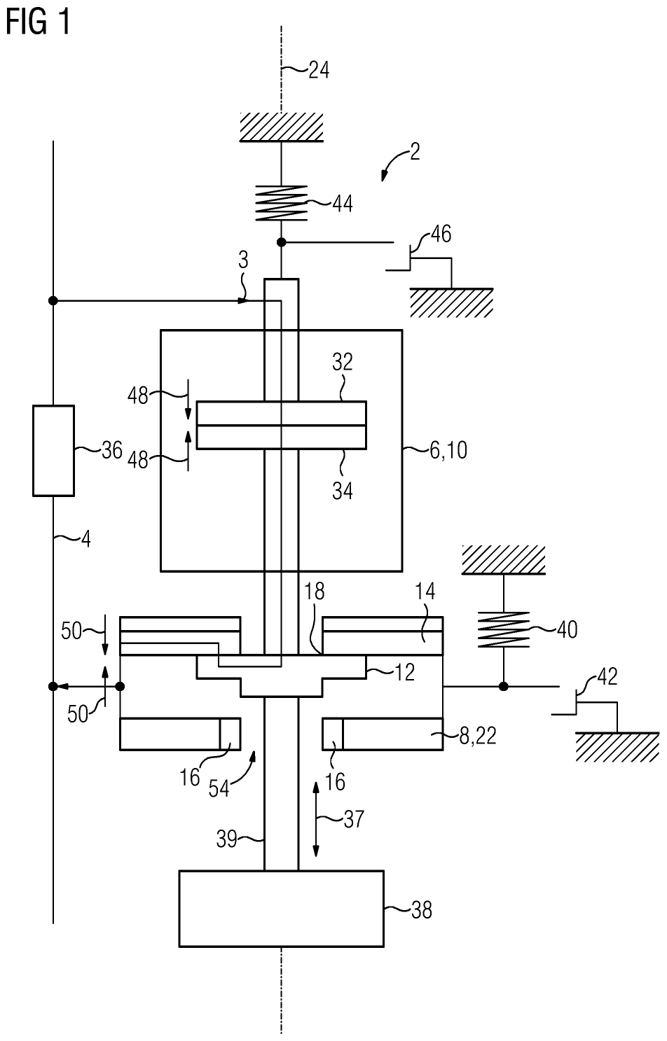

FIG. 1 shows an exemplary embodiment of a switching device with a commutation current path in a closed state,

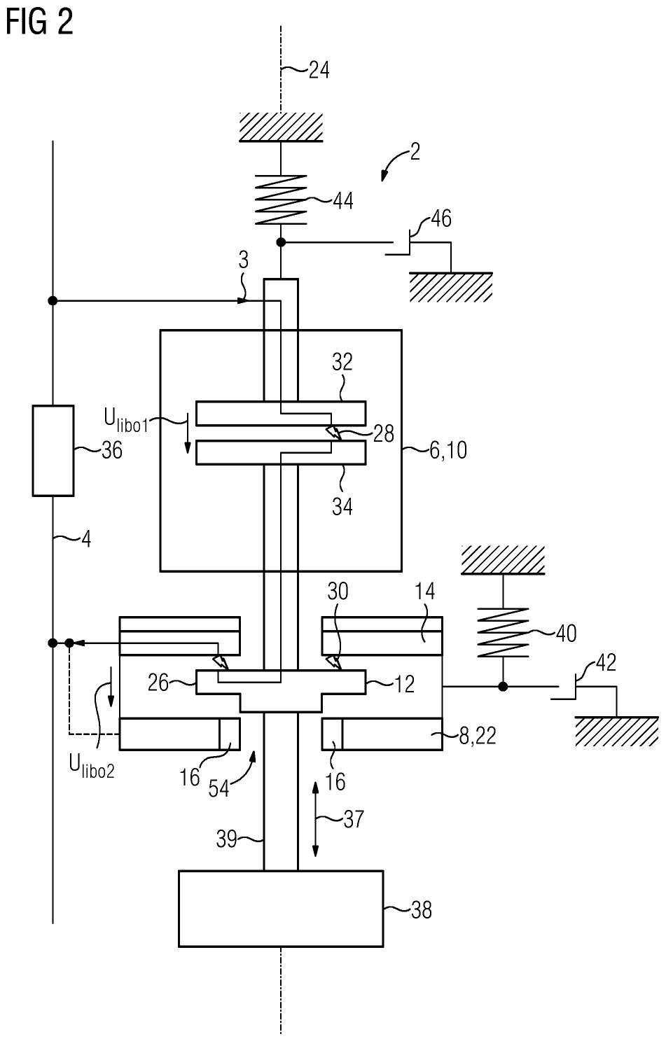

FIG. 2 shows the switching device in a partially open intermediate state with switching arcs,

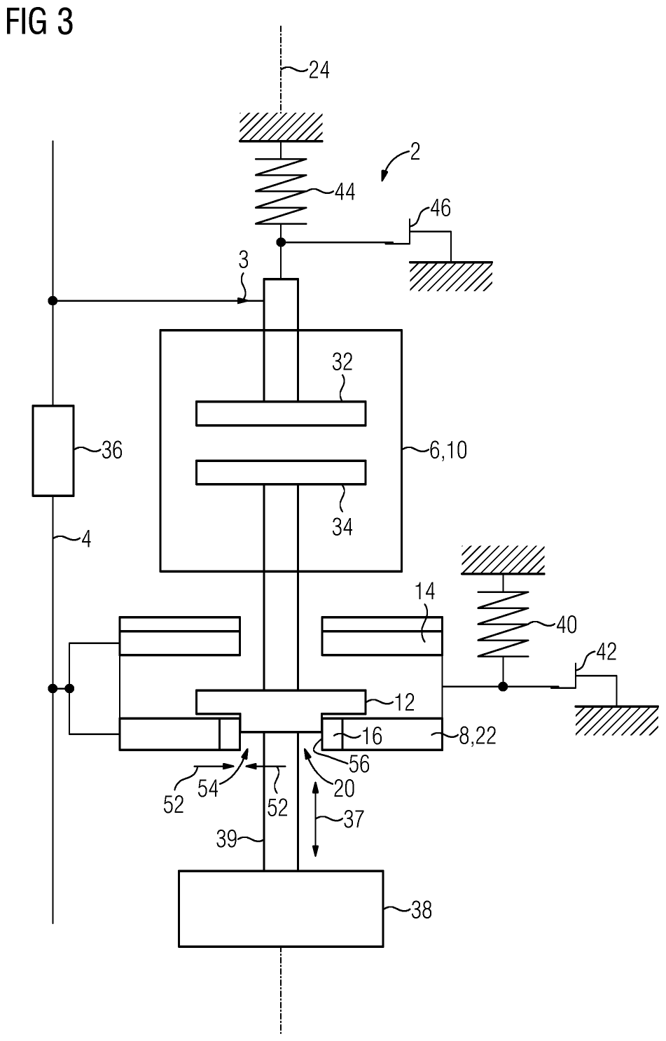

FIG. 3 shows the switching device in a partially open intermediate state with switching arcs,

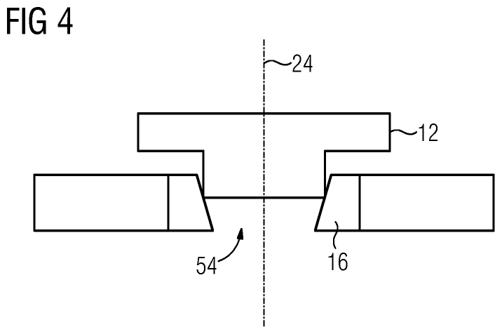

FIG. 4 shows an exemplary embodiment with a conical recess of the third contact.

FIG. 1 shows an exemplary embodiment of a switching device 2 that has a rated current path 3 and a commutation current path 4. The rated current path 3 runs through at least two isolating gaps: a first isolating gap 6 and a second isolating gap 8. In this example, a fuse 36 is arranged in the commutation current path 4. In principle, however, a (particularly fast-switching) semiconductor element (semiconductor switching element) can also be arranged in the commutation current path 4 to interrupt the current flow in the commutation current path 4. Further electrical elements can optionally be arranged parallel to the commutation current path 4 or parallel to the fuse 36 or to the semiconductor element.

The first isolating gap 6, which in this case is designed as a vacuum interrupter 10, has the property that, compared to conventional gas isolating gaps, the vacuum interrupter can produce a high level of insulation with a very short switching stroke, which is also accomplished in a shorter time with a conventional actuator 38 compared to a longer switching stroke. For the same insulating properties, a comparable gas isolating gap would have to have a signifi-cantly longer stroke, which is why the switch-off time of such a switching device would be longer compared to the use of the vacuum interrupter 10.

The second isolating gap 8, which in this example is designed as a gas isolating gap 22, has three contacts. A first contact 12 is designed as a movable contact. The first contact 12 is mounted for translational movement along a switching axis 24 by the drive 38, which also implements the movement of the first isolating gap. The first isolating gap 6 and the second isolating gap 8 are rota-tionally symmetrical with respect to the switching axis 24; the switching axis 24 therefore also represents an axis of symmetry.

The drive drives a switch rod 39 in translation. This results in a translatory drive movement 37. In the exemplary embodiment, the drive 38 is designed in such a way that it advantageously drives the first isolating gap 6 and the second isolating gap 8 together. In principle, however, two independent drives can also be used with other switching devices.

The first contact 12 of the second isolating gap 8, i.e., the gas isolating gap 22, can be moved back and forth between the second contact 14 and the third contact 16. In the closed state of the switching device 2 as shown in FIG. 1, the first contact 12 is in contact with the second contact 14. In the closed state, this means that a fixed contact 32 and a moving contact 34 of the first isolating gap 6, i.e., the vacuum interrupter 10, are in galvanic contact, so that the rated current path 3 is closed. The galvanic contact pairing between the first contact 12 and the second contact 14 of the second isolating gap 8 also has galvanic contacting in the closed state of the switching device 2, through which the rated current path 3 runs. In the closed state of the switching device 2 according to FIG. 1, a first mechanical contact force 48 occurs between the fixed contact 32 and the moving contact 34 of the first isolating gap 6, which acts or extends in the axial direction (with respect to the switching axis 24). This first contact force causes the first isolating gap 6 to close securely. The first contact force 48 is generated by the drive 38. A spring mounting 44 of the first isolating gap 6 results in improved contact. In particular, the 24 spring mounting 44 ensures that sufficient contact pressure can be achieved, which contributes to stronger galvanic contacting.

In the closed state of the switching device 2 according to FIG. 1, a second mechanical contact force 50 occurs between the first contact 12 and the second contact 14 of the second isolating gap 8, which acts or runs in the axial direction (with respect to the switching axis 24). This second contact force 50 causes the second isolating gap 8 to close securely in the first contacting position 18. The second contact force 50 is generated by the drive 38. A spring mounting 40 of the second isolating gap 8 results in improved contacting. In particular, the spring mounting 40 ensures that sufficient contact pressure can be achieved, which contributes to stronger galvanic contacting.

FIG. 2 shows an intermediate state 26 of the switching device 2, which occurs during an opening movement of the switching device 2. The translatory opening movement is performed by the drive 38 along the switching axis 24. In the intermediate state 26, the first contact 12 of the second isolating gap 8 is located between the second contact and the third contact 16. The intermediate state 26 is adynamic state that ends in the state shown in FIG. 3.

FIG. 3 shows the open state of the switching device 2. The first isolating gap 6 is open. The second isolating gap 8 is in a second galvanic contacting position 20. The second galvanic contacting position 20 occurs between the first contact 12 and the third contact 16. The first contact 12 of the second isolating gap 8 is in contact with the third contact 16. The second contact 14 and the third contact 16 are at the same electrical potential and are connected to a node of the rated current path 3. This means that the moved first contact 12 of the second isolating gap 8 is at the same electrical potential as the second contact 14 and the third contact 16 both when the switching device 2 is open and when it is closed. The second isolating gap 8 is therefore also closed in the second contacting position 20. This has the advantage that the first contact 12 (and also the moving contact 34) is at a defined electrical potential.

When the switching device 2 is open, i.e., at the second contacting position 20 of the second isolating gap 8, a third mechanical contact force 52 occurs between the first contact 12 and the third contact 16 in a radial direction (with respect to the switching axis 24). As a result, advantageously, no bouncing occurs between the first contact 12 and the third contact 16 when closing. In addition, no special accuracy requirements with regard to the axial position of the third contact 16 have to be met when manufacturing the switching device.

In the exemplary embodiment, the third contact 16 is a clamping contact; the third contact force 52 is a (radially acting) clamping force. To generate the third contact force 52, the third contact 16 has resilient contact elements 56. The resilient contact elements 56 can, for example, be resilient contact plates. In particular, the contact elements 56 can be resilient in a radial direction.

The third contact 16 has a recess 54. In the second contacting position 20 shown in FIG. 3, the recess 54 accommodates part of the first contact 12. This allows the switching device 2 to have a compact design. The recess 54 can be designed in various ways.

The intermediate state 26 according to FIG. 2 is inter-esting in that a switching arc 28, 30 forms between the contacts in both the first isolating gap 6, i.e., in the vacuum interrupter 10, and in the second isolating gap 8, i.e., in the gas isolating gap 22. An arc 28 is formed between the fixed contact 32 (first contact 32) and the moving contact 34 (second contact 34) of the vacuum interrupter 10. A corresponding switching arc 30 is formed between the first contact 12 and the second contact 14 of the gas isolating gap 22. The two switching arcs 28 and 30 differ in particular in the level of the voltage dropping in them, i.e., the arc voltage. In the exemplary embodiment, the arc voltage U_{libo2} in the switching arc 30 in the gas isolating gap 22 is higher than the arc voltage U_{libo1} in the switching arc 28 in the vacuum interrupter 10. This is because gas molecules are ionized in the gas isolating gap 22, which leads to a higher applied voltage. A vacuum pre-vails in the vacuum interrupter 10, which leads to a lower arc voltage. In general, the arc voltage U_{libo2} in the switching arc 30 in the gas isolating gap 22 is at least equal to (or greater than) the arc voltage U_{libo1} in the switching arc 28 in the vacuum interrupter 10.

The higher arc voltage U_{libo2} in the gas isolating gap 22 results in improved commutation of the current from the rated current path 3 to the commutation current path 4, so that safe commutation in the commutation current path 4 is en-sured. If only the vacuum interrupter 10 were used in the rated current path 3, there would be a conflict of objectives between the highest possible impedance of the commutation current path 4 for normal operation and the lowest possible impedance of the commutation current path 4 for the short-circuit case. Due to the gas isolating gap 22 with the described structure, the commutation of the current in the commutation current path 4 can also take place at a higher impedance of the commutation current path 4, which reduces the risk of unintentional triggering of the fuse 36 during normal operation.

In order to ensure a certain contact pressure both in the first isolating gap 6 and in the second isolating gap 8, it is advantageous for the contact systems of both isolating gaps 6, 8 to be spring-mounted. The spring mounting 44, which is shown in various deflections in FIGS. 1-3, is provided on the first isolating gap 6. In FIG. 1, the spring mounting 44 is tensioned. In FIG. 2, the spring mounting 44 is deflected so that one end moves towards a stop 46. In FIG. 3, the end of the spring mounting 44 is in contact with the stop 46. The resilient mounting of the contacts means that the first contact 32, which is substantially designed as a fixed contact 32, is pressed by the spring mounting 44 against the movable second contact 34, which is in operative connection with the drive 38, in the closed state.

The first contact 14 and the second contact 16 of the gas isolating gap 22 are also resiliently mounted in translation along the switching axis 24 as shown in FIGS. 1-3. The spring mounting 40 is provided for this purpose and is tensioned in the closed state of the second isolating gap 8, as shown in FIG. 1. In the intermediate state as shown in FIG. 2, the spring mounting 40 is deflected so that one end of it moves towards a stop 42. In the open state as shown in FIG. 3, the end of the spring mounting 40 is in contact with the stop 42. At this point, the first contact 12 is in galvanic contact with the third contact 16.

In FIGS. 1-3, the recess 54 of the third contact 16 is substantially hollow-cylindrical in shape in the direction of the switching axis 24.

FIG. 4 shows an exemplary embodiment in which the recess 54 of the third contact 16 is substantially conical in the direction of the switching axis 24. The cone is shown exag-gerated in the figure for better recognizability.

Alternatively, the first contact 12 can also be conical in the direction of the switching axis 24. In particular, the part of the first contact 12 that is received by the recess of the third contact 16 at the second contacting posi-, tion 20 can be conical in the direction of the switching axis 24.

A switching device has been described that can be manufactured at low cost. Advantageously, this switching device does not bounce when it reaches its open switching position.

### LIST OF REFERENCE SIGNS

2 switching device
3 rated current path
4 commutation current path
6 first isolating gap
8 second isolating gap
10 vacuum interrupter
12 first contact
14 second contact
16 third contact
18 first contacting position
20 second contacting position
22 gas isolating gap
24 switching axis
26 intermediate state
28 switching arc first isolating gap
30 switching arc second isolating gap
32 fixed contact first isolating gap
34 moving contact first isolating gap
36 fuse
37 drive movement
38 drive
39 switch rod
40 spring mounting second isolating gap
42 stop spring mounting second isolating gap
44 spring mounting first isolating gap
46 stop spring mounting first isolating gap
48 first contact force
50 second contact force
52 third contact force
54 recess
56 resilient contact element
U_{libo1} arc voltage of the switching arc of the first isolating gap
U_{libo2} arc voltage of the switching arc of the second isolating gap

1-15. (canceled)

16. A switching device, comprising:
a commutation current path, a first isolating gap, and a second isolating gap;
said first and second isolating gaps forming an electrical series circuit arranged in parallel with said commutation current path;
said second isolating gap having a first contact, a second contact, and a third contact;
said first contact being a moving contact being mounted movably along a switching axis from a first galvanic contacting position with said second contact to a second galvanic contacting position with said third contact;
said second contact and said third contact being at an electrical potential; and
wherein, when said first contact is in the second contacting position, a mechanical contact force acts between said first contact and said third contact in a radial direction.

17. The switching device according to claim 16, wherein said third contact is a clamping contact and the contact force is a clamping force.

18. The switching device according to claim 16, wherein said third contact (16) has resilient contact elements.

19. The switching device according to claim 16, wherein said third contact is formed with a recess configured to receive, at least partially, said first contact in the second contacting position.

20. The switching device according to claim 19, wherein said recess has a substantially hollow-cylindrical shape.

21. The switching device according to claim 19, wherein at least one of said recess or said first contact has a conical shape.

22. The switching device according to claim 16, wherein said second isolating gap is a gas isolating gap.

23. The switching device according to claim 16, wherein said second contact and said third contact of said second isolating gap are resiliently mounted in a direction of the switching axis.

24. The switching device according to claim 16, wherein, during a switching operation, said first, second, and third contacts are disposed in an intermediate state in which said contacts of both said first isolating gap and said second isolating gap are galvanically contactless.

25. The switching device according to claim 24, wherein, in the intermediate state, a switching arc occurs between the contacts of said first isolating gap and a switching arc occurs between the contacts of said second isolating gap.

26. The switching device according to claim 25, wherein the switching arc of said second isolating gap occurs between said first contact and said second contact.

27. The switching device according to claim 16, wherein said commutation current path comprises at least one of a fuse or a semiconductor element.

28. The switching device according to claim 16, wherein said first isolating gap has a fixed contact and a moving contact, said moving contact of said first isolating gap is mounted for movement in translation along a switching axis, and, when said first isolating gap is closed, a mechanical contact force acts in the axial direction between said moving contact and said fixed contact.

29. The switching device according to claim 16, wherein said first isolating gap is a vacuum isolating gap.

30. The switching device according to claim 29, wherein said vacuum isolating gap is a vacuum interrupter.

31. A method for switching electric current, the method comprising:
providing a switching device according to claim 16; and
with the first and third contacts being in the second contacting position, generating a mechanical contact force in the radial direction between the first contact and the third contact.
